(19) United States
(12) Patent Application Publication
(10) Pub. No.: US 2009/0179758 A1
(43) Pub. Date: Jul. 16, 2009

(54) SITE SECURITY SYSTEM

(76) Inventor: Jason G. Squier, Cleveland, TX (US)

Correspondence Address: CONLEY ROSE, P.C.;David A. Rose, P. O. BOX 3267, HOUSTON, TX, 77253-3267, US

(21) Appl. No.: 12/353,547

(22) Filed: Jan. 14, 2009

Related U.S. Application Data
(60) Provisional application No. 61/020,818, filed on Jan. 14, 2008.

(51) Int. Cl. E05B 45/06; E05G 1/02; E05G 1/10

(52) U.S. Cl. 340/542; 109/23; 109/58

(57) ABSTRACT

A system for securing a property site includes a fence adapted to enclose the property site. Reinforcements are placed over the wire fence. A gate in the fence allows access to the property site and includes a locking member to lock the gate. A secured access member secures a key member to unlock the locking member. Detectors are used to monitor the property site for intruders and to send a signal upon detecting an intruder. An interface is disposed on the secured access member for deactivating the detectors and unlocking the secured access member.

### CROSS-REFERENCE TO RELATED APPLICATIONS

The present application claims the benefit of U.S. Provisional Application No. 61/020,818 filed Jan. 14, 2008, the disclosure of which is hereby incorporated herein by reference.

### STATEMENT REGARDING FEDERALLY SPONSORED RESEARCH OR DEVELOPMENT

Not applicable.

### BACKGROUND

1. Field of the Invention

This invention relates generally to the field of securing a property site. More specifically, the invention relates to an apparatus and method for protecting a telecommunications site, such as a cellular tower site, from vandals.

2. Background of the Invention

Many commercial properties are left unattended for long periods. Further, these sites are used for storage including valuable buildings, inventory, components, equipment, and personal assets. The unattended storage of assets make these properties prime targets for vandals and thieves. One such property site is a telecommunications site having expensive and valuable installations and equipment. A significant portion of the telecommunications infrastructure is constructed of copper and copper alloys. Copper is often used as a conductor, and when insulated makes for an excellent electric signal transducer. Furthermore, copper is often used to ground, or protect wireless telecommunication towers from lightning strikes.

High demand coupled with low supplies of these metals metal has driven recycling companies to offer large financial compensations for reclaimed copper. Thieves, vandals and even competing companies' technicians have recently begun pilfering cellular telecommunication towers for copper containing materials. The number of copper containing components in telecommunication sites, coupled with their remote, unsecured, and/or lightly secured sites have made them prime targets for theft. The consequences have been outages to consumers, loss of coverage for the provider, in some cases complete loss of the tower due to lightning strikes and financial damages to the company owning the tower.

Currently the means to secure a property site are limited to razor wire, chain link fences, padlocks, and surveillance cameras. These measures have not stymied the theft of installation components and equipment such as copper components from these sites. Razor wire, chain link fences, and padlocks are easily defeatable by hand held tools. In extreme cases, they are incapable of securing the site against vehicular leverage: such as pulling open a gate, pulling down a fence, or ramming a gate. In the case of surveillance camera systems, they provide only retroactive means to identify the thief.

Consequently, there is a need for a system for securing a property site that is resistant to thieves and vandals, including the use of vehicles. Other objects and advantages of the invention will appear from the following description.

### BRIEF SUMMARY

A security system for securing a property site includes a multi-component security fence adapted to enclose the property site. Reinforcements are placed over the wire fence. A gate in the fence allows access to the property site and includes a locking member to lock the gate. A secured access member secures a key member to unlock the locking member. Detectors are used to monitor the property site for intruders and to send a signal upon detecting an intruder. An interface is disposed on the secured access member for deactivating the detectors and unlocking the secured access member.

The secured access member includes an enclosure disposed within the security fence and accessible through the fence or gate. The enclosure has a near side adjacent to the fence or gate, a back side opposite the near side and away from the fence or gate, and an access side extending between the near side and back side. The access side has a pivotal door with a lock and the enclosure houses the key member to the gate lock. An activation member is disposed on the back side of the enclosure to unlock the door to access the key member.

The foregoing has outlined rather broadly the features and technical advantages of the invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates a top view of a telecommunications tower security system;

FIG. 2 illustrates a three quarters elevation of a telecommunications tower security system;

FIG. 3 illustrates a detail of a key safe.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

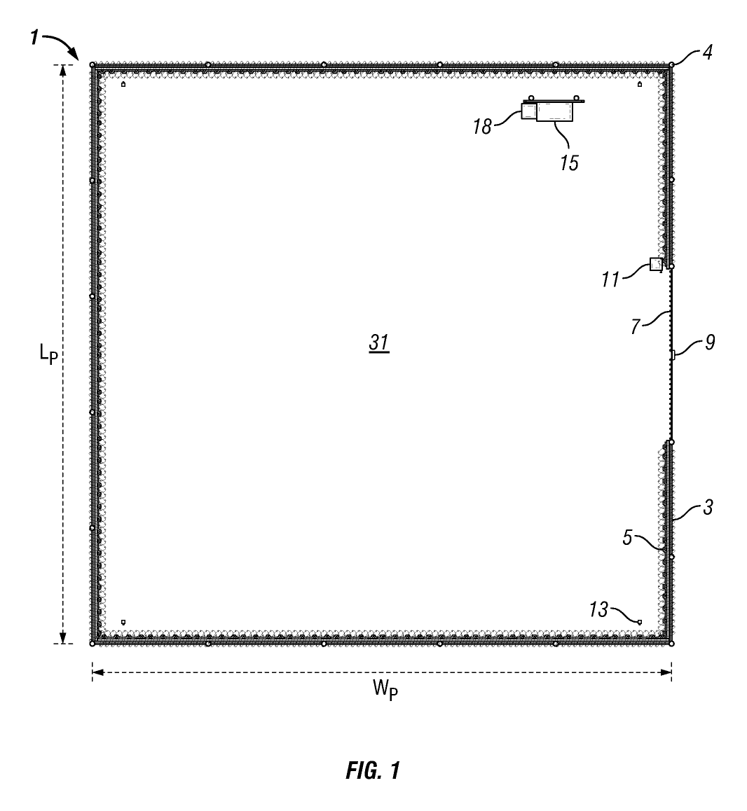

Referring now to FIG. 1, illustrating an exemplary embodiment of a property site security system. In embodiments, the property site 1 has a perimeter with dimensions Lp by Wp. In certain embodiments, the perimeter is smaller than the property site 1. The property site 1 includes a fence 3 around the property site. The fence 3 is the outermost structure on the site. The fence 3 comprises a chain link fence extending around the perimeter of the property site. The fence 3 may be constructed of any gauge chain link, such as 11 gauge, 12 gauge or other gauges as known to one skilled in the art. Alternatively, the fence 3 comprises a wrought iron, metal pike, or high-tension wire. In certain embodiments, the fence 3 is a pre-existing structure.

For new construction of the fence 3, the fence posts 4 are positioned so that they each extend into a posthole in the ground. The fence posts 4 have a diameter between about 2 inches and about 4 inches, preferably between about 2 inches and 3 inches, in an exemplary embodiment the fence post is 2.375 (2⅜) inches in diameter. In embodiments, the fence posts extend about 12 inches to about 36 inches into the ground, in preferred embodiments about 18 inches to about 32 inches below ground level. Alternatively, the postholes extend more than about 36 inches underground. The postholes have a diameter greater than that of the posts 4 to provide an annular area there-around to be filled with cement. Preferably the diameter of the post holes is 8 inches greater than the diameter of the posts 4. Without being limited by theory, the larger the diameter of the fence post 4 and the deeper the fence post 4 is positioned into the ground and the more concrete supporting the posts, the less likely the fence is to be toppled by weather, tree falls, and accidental and/or intentional vehicle contact.

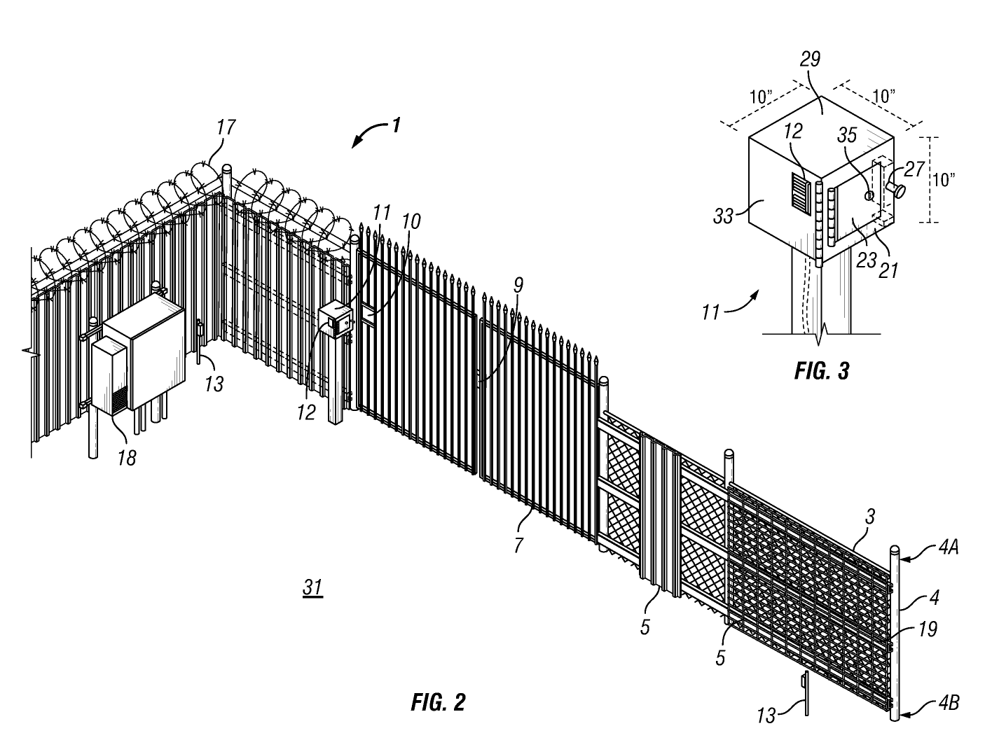

Referring now to FIG. 2 the fence posts 4 are connected by a plurality of horizontal bars 19. In embodiments, the fence posts 4 are connected by at least two horizontal bars 19. In certain instances, at least one horizontal bar 19 is disposed near the top of the fence post 4a, and at least one horizontal bar 19 is disposed near the bottom of the fence post 4b. For additional strength a third horizontal bar 19 can be disposed between, at or about the midpoint of the fence post 4. In embodiments, the horizontal bars 19 are constructed of metal. In preferred embodiments, they are constructed of C channels and/or boxed steel. In certain instances, the horizontal bars 19 can be considered steel 2 inches by 4 inches. It is understood by one skilled in the art that alternative rectangular dimensions of the horizontal bars 19 are envisioned, as components are available in a given market. Further, alternative shapes and dimensions are envisioned, as necessary for physical strength of the fencing system. The horizontal bars 19 are welded to the fence posts 4. Additionally, they are bolted to the fence posts 4. Furthermore at the corners of the site 1, the horizontal bars 19 are welded together. Welding each of the horizontal bars 19 to the fence posts and other horizontal bars 19 creates a structure that is stronger. In certain embodiments, to further reinforce the corners of the site 1, the fence posts 4 have a larger diameter, or extend deeper underground.

Security panels 5 are secured to the horizontal bars 19. The security panels 5 act as a privacy fence. The panels 5 are constructed of solid, opaque, or translucent material to prevent visibility into the site. The panels 5 may be constructed of wood, plastic, polymers, aluminum, steel, tin, composites, alloys or combinations of material that are capable of creating line of sight interferences. Additionally, the panels 5 are resistant to cutting, or bending. This may be a feature of the material, or dependent on the thickness of the material. The resistance to cutting and bending is a preferred physical property to deter thieves from attempting to cut or bend the fence, and/or panels, to gain access to the site 1. In certain instances, the panels 5 are constructed of galvanized steel and are preferably vertical. Alternatively, the panels 5 are constructed out of closely spaced galvanized steel rods. In certain instances, the closely spaced galvanized steel rods comprise a ‘wire wall’ or the like, without limitation. As understood by one skilled in the art, the passage of air through the panels 5 may be beneficial in maintaining the integrity of the site during inclement weather, for instance the high winds of a hurricane. Additionally, the steel rods are space tightly such that the distance between rods is insufficient to pass a hand held cutting implement. In certain instances, the wire wall and solid panels may be alternated in a single site 1 installation.

The panels 5 extend the full height of the chain link fence 3. The height of the chain link fence 3 may be between about 5 feet and about 8 feet tall, preferably between about 5 feet and about 7 feet, and most preferably between about 6 feet and about 7 feet. In further applications, the panels 5 may extend below the ground level. In certain instances, the panels 5 may extend at least about as far underground as the fence posts 4.

The fence being constructed with chain link 3 and panels 5 is a physical deterrent against access to the property site 1 using handheld cutting or bending tools. However, these tools are not necessary if the thief chooses to circumvent the fence by climbing over it. In order to prevent or discourage unauthorized access by climbing over the fence, razor wire 17 maybe disposed at the top of the fence. In embodiments the razor wire 17 maybe include coils, linear high tension or combinations there of, disposed between the posts. In alternative embodiments, the razor wire 17 may be extended outward from the site, such as a bracket disposed at an angle to the post, to create an additional barrier to access. Combinations of directionally angled razor wire 17 may further interfere, discourage, or prevent unauthorized access

An enclosure is formed by the fence 3 and an access means such as a gate 7. Access to the site 1 is facilitated by the gate 7. The gate is pivotably disposed at a fence post 4 at an opening in the fence. The gate 7 may be one piece having one or more hinges. Alternatively, the gate 7 may be two swinging gates each having a plurality of hinges, such that the gate 7 has two components that pivot independently and swing open. The gate 7 represents a vulnerability to the security of the site. In embodiments, the gate 7 is constructed out of a material that is resistant to cutting, burning, or vehicular impacts. The gate 7 can be solid, slatted, or barred as a means to increase the strength of the gate 7. In order for service persons to visually inspect the site quickly, it may be necessary for the gate 7 to be slatted. In embodiments, the gate 7 is constructed of cast iron or galvanized steal, with vertical pikes comprising the slats. In order to prevent a thief from slipping between the pikes or slats it is necessary that the distance between each pike is between about 2 inches and about 6 inches, most preferably between about 3 inches and about 4 inches. In alternative embodiments, the pikes are vertically oriented bars, with points disposed at the top. The gate 7 can have spikes disposed at the top of the pikes or slats. Additionally, the gate 7 includes razor wire 17 disposed at the top of the gate to deter a thief from climbing over the gate. The gate 7 further comprises reinforced hinges. In certain embodiments, hinges are reinforced such that the hinge pin, or hinge axis, is resistant to tampering, extraction, and/or removal from gate 7.

When closed, it is necessary to secure the gate 7 to form a lockable enclosure. Typically, at least one padlock is used to lock the gate 7. In certain instances, gate 7 may include integrated lock. Locks are easily defeated by picks, lock cutters, pry bars, and/or heavy impacts. In order to protect a lock from such attacks, a securing means, such as a lock box 9, is constructed on the gate 7. The lock box 9 is constructed around the padlock on the gate 7. In embodiments the lock box is constructed out of plate steal, galvanized steel or other suitable materials. The lock box 9 is entirely sealed, except from below, where it can be accessed. Furthermore, the lock box 9 narrowly fits about the padlock, and/or lock. In embodiments, the construction of the lock box 9 prevents the pry bars, lock cutters or objects from striking and breaking the lock. Additionally, the lock box 9 is constructed so that it is difficult for a lock pick to be manipulated in the lock. Without being limited by theory, limited access from below the lock makes it difficult to maneuver hands and picking devices into the lock box 9. Furthermore, the person attempting to access the lock must assume an untenable position in order to reach the lock.

Referring now to FIG. 3, to control the personnel that have access to the key to the padlock, an additional layer of security is added. In embodiments, the property site 1 includes a secured access apparatus, to control access of authorized personnel. A secured access apparatus comprises a box, q safe, and/or another storage assembly. Secured access apparatus comprises key safe 11 located within the perimeter defined by the fence 3 and the gate 7, but it is accessible from outside the perimeter. The key safe 11 is preferably located near the gate 7, so that a person can reach into the perimeter and obtain a key to the padlock. It should be appreciated that the key safe 11 can be located anywhere along the inside perimeter of the fence 3. The key safe 11 is within about an average human arm's reach through the fence 3. In certain instances, this distance is less than 18 inches inside the perimeter and near the gate 7 hinges. The key safe 11 is disposed at the top of a pole or support near at a height Hₚ from the ground. In certain embodiments, the key safe 11 is disposed at the top of a 4 inch by 4 inch steel pole. The key safe 11 is positioned so that the accessible means of the box are perpendicular to the gate. Alternatively, the accessible means of the box are oriented parallel to the gate, such that they are perpendicular to a persons line of site through the gate. In certain embodiments, a reinforced access portal 10 in the pikes of the gate allows access to the key safe 11. The portal 10 allows a person to pass an arm through the gate 7 and reach the key safe 11.

The key safe 11 is a rectangular box having dimensions L_{b} by W_{b} by H_{b}. In embodiments the key safe is about 10 inches by about 10 inches by about 10 inches. In alternate embodiments the key safe 11 may have different dimensions. The key safe is constructed out of sheet metal, galvanized steel, or other materials as known to one skilled in the art. The key safe 11 comprises a sealable box 29, a pivotable face side 21, a small door 23 disposed on the pivotable face side 21, and an electronic card swipe 12 disposed on the exterior of a back side 33 of the key safe 11. The face side 21 is preferably perpendicular to the fence 3 and the back side 33 is preferably parallel to the fence 3.

The pivotable face 21, is connected to the key safe 11 by a reinforced hinge 25, and secured by an internal deadbolt 27. The reinforced hinge is disposed on the corner of the key safe 11 formed by the face side 21 and back side 33 away from the gate 7.

Disposed on the pivotable face side 21 is a small door 23 having a key lock 35 for easy access to the key safe 11 by the site owner or other authorized personnel. The small door 23 is preferably constructed of the same material as the key safe 11. The internal deadbolt 27 may lock both the face side 21 and the small door 23. This allows the small door 23 to also be unlocked by the internal deadbolt 27; the deadbolt 27 can be considered the master deadbolt, as an identification card is not required to access the interior of the key safe 11. In order to maintain high standards of security, it is envisioned only the site owner would retain the key to this lock.

The card swipe 12 is located on the back side 33 opposite from the gate 7. The location of the card swipe 12 on the backside 33 of the key safe 11 hides it from view. For instance, when viewed from the gate 7, card swipe is not visible. Additionally, this location impedes tampering with the card swipe 12. Further, card swipe 12 is configured such that the key safe 11 disabled by tampering, damage, weather, or defect then the system locks the site 1 until properly serviced by authorized personnel. In certain embodiments, the card swipe 12 is an IEI Minimax 2 (IE-MINMX2SK1) card reader.

The card swipe 12 electronically unlocks internal deadbolt 27 of the key safe 11 allowing access to a key to the gate padlock box 9. In certain instances, a service provider employee swipes an identification card past the card swipe 12. The card swipe 12 records an identification number unique to that service provider and employee. Additionally, the card swipe is verified against a database of authorized users.

In further embodiments, the site 1 includes detectors, sensors, monitors, or the like, configured for detecting the presence of intruders. The detectors may be alarm triggers 13 such as laser beams, motion detectors, heat detectors or combinations thereof. In an exemplary embodiment, the alarm triggers 13 are Optex (OP-AX70TN) laser and photo-beams. The alarm triggers 13 monitor the interior space of the site 1. The alarm triggers can be located in any portion of the interior space 31 of the site 1 such that they provide maximal coverage of the site 1. The rectangular shape of a most property sites allows the alarm triggers 13 to be placed in the corners. Additionally, this reduces the risk of the triggers 13 being damaged by vehicles during maintenance or service. Alternatively, for properties comprising alternative shapes, the alarm triggers 13 may be positioned in alternate locations, without limitation.

During maintenance or service, it may be necessary to leave or store vehicles or equipment within the site 1. The equipment represents a potential obstacle for the alarm triggers 13. Additionally during construction, the site is particularly vulnerable to metal thieves, and it may be necessary to have an operational security system in place prior to ground breaking, construction, and/or installation. During construction there may be a number of people and equipment within the interior space 31. In these situations, it may be necessary to move the triggers 13 to a safe location during the workday and replace them during the evening. In embodiments the triggers 13 may be repositioned, rotated, and/or otherwise manipulated, without limitation, to monitor the site for the duration of equipment storage.

Without being limited by theory, the passive alarm triggers 13 observe an unauthorized person or persons moving within the interior space and send an electric signal to the alarm control box 15. The alarm control box 15 sends an electronic signal to a remote monitoring location notifying them of an intrusion immediately. In certain embodiments, the remote monitoring location may be a police station, a security company, a site owner or landlord, or combinations thereof. In additional embodiments, the alarm control box 15 may further trigger onsite alarms.

Onsite alarms may include auditory, such as but not limited to a siren; and visual alarms, such as, but not limited to, strobe lights. Due to the intrusive nature of these devices in urban, suburban, and/or residential areas, the alarm control box 15 will include a computer to analyze the signal from the alarm triggers. The computer or alarm control box 15 is configured to determine if the intrusion is caused by natural objects, animals, or air born debris before signaling the remote monitoring location or triggering the onsite alarms. In further envisioned embodiments, the computer is configured to manage the property site. The computer may log entrance and exit or personnel for billing purposes. Alternatively, computer may be configured to unlock gate 7 or internal deadbolt 27 remotely. The alarm control box 15 may be used to manage the site, and/or any inventory, material, vehicles, and the like, without limitation, from a remote location.

The location of a computer system within the alarm control box 15 may be anywhere within interior space of the site 1. The alarm control box 15 is comprised of a weatherproof casing to protect the computer and components. In order to keep the system operational under unexpected circumstances, the alarm control box 15 includes an auxiliary box 18. In embodiments the auxiliary box 18 includes a cooling system. The cooling system extracts heat, vents, or cools the interior of the control box 15. As understood by one skilled in the art, severe temperatures may damage the computer system.

An emergency power system may be included in the alarm control box 15 or auxiliary box 18. Without being limited by theory the emergency power system provides electrical power to the alarm control box in the event of a power outage. The emergency power system is designed to give back up power for about 8 hrs to about 24 hrs. In embodiments, the emergency power system may be a battery, a generator, a capacitor, or other devices as known in the art. In the event the emergency power supply is exhausted, the alarm control box completely locks the access points to the site 1. The loss of power additionally disables the card swipe 12. When a service person requires access to the site 1, they may gain access to the key safe 11 by contacting the owner of the site for the key.

While the preferred embodiments of the invention have been shown and described, modifications thereof can be made by one skilled in the art without departing from the spirit and teachings of the invention. The embodiments described and the examples provided herein are exemplary only, and are not intended to be limiting. Many variation and modifications of the invention disclosed herein are possible and are within the scope of the invention. Accordingly, the scope of protection is not limited by the description set out above, but is only limited by the claims which follow, that scope including all equivalents of the subject matter of the claims.

We claim:

1. A system for securing a property site, comprising:
a fence, adapted to enclose the property site, having a gate and locking means;
reinforcements covering the wire fence;
a secured access apparatus for securing a key member to unlock the locking means, disposed within the fence, and accessible by a person from outside the fence;
detectors, configured to monitor the property site and transmit a signal upon detecting an intruder; and
an interface for deactivating the monitoring security system and unlocking the secured access apparatus.

2. The system of claim 1, wherein the reinforcements are chosen from the group of structures impenetrable by a person comprising metal panels, polymer panels, wire walls, and combinations thereof.

3. The system of claim 1, comprising at least one access portal configured to permit a person to reach the secured access apparatus.

4. The system of claim 1 wherein the secured access further including a secure structure housing the locking member.

5. The system of claim 1, wherein the detectors comprises at least one chosen form the group comprising optical detectors, laser beams, motion detectors, infrared lights, and combinations thereof.

6. The system of claim 5, wherein the detectors are in communication with a computer configured to transmit a signal.

7. The system of claim 6, wherein the computer is configured to receive a signal.

8. The system of claim 1, wherein the secured access member comprises a metal box having a lockable hinged door.

9. The system of claim 8, wherein the secured access apparatus further comprises a card reader to open the lockable hinged door.

10. The system of claim 8, wherein the secured access member includes an enclosure having an internal locking mechanism.

11. The system of claim 10 wherein the internal locking mechanism comprises a locking mechanism chosen from the group comprising electronic, mechanical, manual and combinations thereof.

12. The system of claim 1, wherein the signal sets off an alarm.

13. A security system for a property site having a security fence with a gate locked with a key member, the security system comprising:
an enclosure disposed within the security fence and accessible through the fence or gate;
the enclosure having a near side adjacent to the fence or gate, a back side opposite the near side and away from the fence or gate, and an access side extending between the near side and back side;
the access side having a pivotal door with a lock and the enclosure housing the key member to the gate lock; and
an activation member disposed on the back side of the enclosure to unlock the door to access the key member.

14. The security system of claim 12, wherein the enclosure is a key safe

15. The security system of claim 12, wherein the activation member is a card reader.

16. The security system of claim 12, further including detectors inside the fence to detect an intruder.

17. A method for accessing a secured property site having a security fence with a gate locked with a key member, the method comprising:
extending at least an arm through the fence or gate into the site through an access portal disposed in the gate;
accessing an interface disposed on an enclosure;
deactivating a monitoring security system and unlocking the enclosure;
opening the enclosure to obtain the key member;
unlocking the gate; and
opening the gate.

18. An apparatus for securably retaining a key, comprising;
an enclosure having a near side adjacent to a user, a far side opposite the near side and away from the user, and an access side extending between the near side and far side;
the access side having a pivotal door with a lock and the enclosure housing the key; and
an activation member disposed on the far side of the enclosure to unlock the door to access the key.

19. The apparatus of claim 18, wherein the enclosure is mounted within a secured perimeter.

20. The apparatus of claim 18, wherein the enclosure comprises a topside, a back side, and a bottom side that extend between the near side and the far side

21. The apparatus of claim 20, wherein the enclosure comprises a safe.
